(19) United States
(12) Patent Application Publication
(10) Pub. No.: US 2024/0354732 A1
(43) Pub. Date: Oct. 24, 2024

(54) POINT OF SALE TERMINAL, METHOD, AND MEDIUM

(71) Applicant: Toshiba Tec Kabushiki Kaisha, Tokyo (JP)

(72) Inventor: Masashi GOTO, Fukuoka Fukuoka (JP)

(21) Appl. No.: 18/587,849

(22) Filed: Feb. 26, 2024

(30) Foreign Application Priority Data
Apr. 24, 2023 (JP) 2023-071031

(51) Int. Cl. G06Q 20/20

(52) U.S. Cl. CPC G06Q 20/208; G06Q 20/209

(57) ABSTRACT

A point of sale (POS) terminal for registering commodities for purchase at a store, includes a code reader, a memory that stores a commodity master with an entry for each commodity sold at a store in association with a full price for the commodity and a discount amount, and a processor configured to upon reading of a code via the code reader, register a commodity corresponding to the code in a transaction, calculate a total amount of payment due in the transaction based on the full price and the discount amount of the registered commodity, generate transaction information indicating an image of a receipt of the transaction, the image including first text indicating the total amount of payment due and second text indicating a total amount of discount, the second text being highlighted relative to the first text, and output the transaction information for printing.

### CROSS-REFERENCE TO RELATED APPLICATION

This application is based upon and claims the benefit of priority from Japanese Patent Application No. 2023-071031, filed Apr. 24, 2023, the entire contents of which are incorporated herein by reference.

### FIELD

Exemplary embodiments described herein relate generally to a point of sale (POS) terminal, a method, and a medium.

### BACKGROUND

Various sales promotion efforts (hereinafter, simply referred to as “promotions”) may be performed at a store, such as a supermarket and a convenience store, for promoting the sale of commodities, revisits, and the like.

A common promotion method is price reduction or discount on a commodity. A target commodity for the price reduction may be promoted through a leaflet, a POP (point-of-purchase) advertisement, or the like, and the reduction amount may also be displayed to a customer at the time of commodity registration and printed on a receipt. In addition to such a promotion, for example, price reduction may be applied to closeout commodities.

However, since price reduction is often applied on a per commodity basis at a store and other stores selling the same commodity may perform similar price reductions to the same commodity, thus a promotional effect of the price reduction may be low and insufficient to encourage customers to revisit the store.

### BRIEF DESCRIPTION OF THE DRAWINGS

FIG. 1 is a schematic diagram showing a POS system.

FIG. 2 is a perspective view showing the appearance of a POS terminal as viewed from an operator side.

FIG. 3 is a block diagram showing a hardware configuration of a POS terminal.

FIG. 4 is a data structure of a commodity master database (DB).

FIG. 5 is a data structure of a member price reduction table.

FIG. 6 is a functional block diagram of a POS terminal.

FIG. 7 is a flowchart of control processing performed by a POS terminal.

FIG. 8 is a diagram showing an example of a receipt issued by a POS terminal

### DETAILED DESCRIPTION

In general, according to one embodiment, a POS terminal, a method, and a medium capable of improving a promotional effect of price reduction are provided.

In one embodiment, a POS terminal for registering commodities for purchase at a store, includes a code reader, a memory that stores a commodity master with an entry for each commodity sold at a store in association with a full price for the commodity and a discount amount, and a processor configured to upon reading of a code via the code reader, register a commodity corresponding to the code in a transaction, calculate a total amount of payment due in the transaction based on the full price and the discount amount of the registered commodity, generate transaction information indicating an image of a receipt of the transaction, the image including first text indicating the total amount of payment due and second text indicating a total amount of discount, the second text being highlighted relative to the first text, and output the transaction information for printing.

Hereinafter, certain example embodiments will be described with reference to the drawings. In such embodiments, a POS terminal 1 is described as an example of a sales data processing apparatus. However, the present disclosure is not limited to the particular example embodiments.

FIG. 1 is a schematic diagram showing a POS system 10 according to an embodiment. The POS system 10 executes sales processing, sales management processing, and the like on commodities sold in a store, and is typically installed at a store. The POS system 10 includes one or more POS terminals 1 installed in the store and a host server 2 installed in a back office of the store. The POS terminals 1 and the server 2 are electrically connected by a communication line L such as a local area network (LAN). Therefore, the POS terminals 1 and the server 2 can communicate with each other, and can transmit information to and receive information from each other.

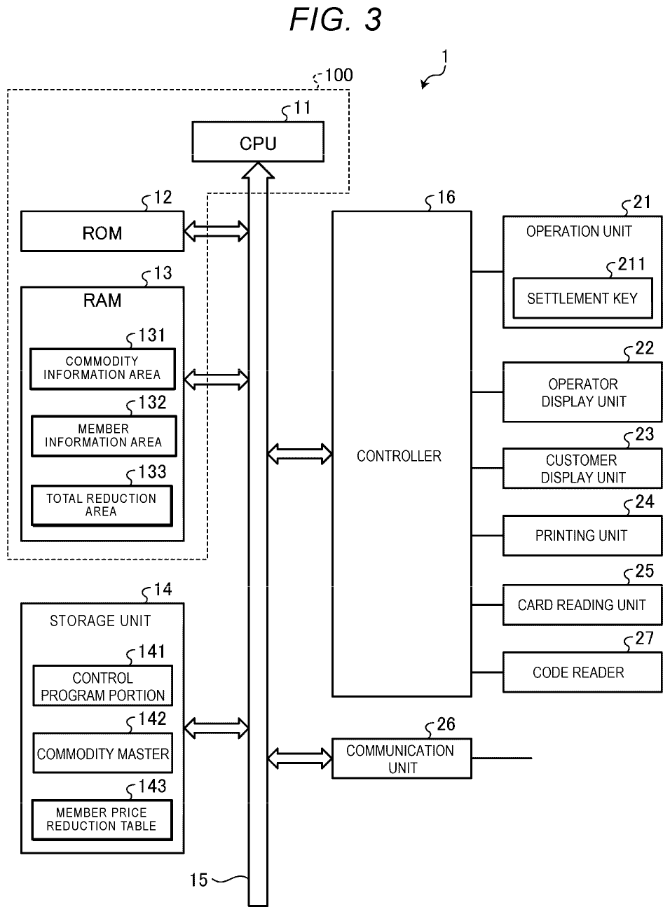

In a transaction with a customer, the POS terminal 1 executes commodity registration processing and settlement processing for a commodity purchased by the customer. The POS terminal 1 captures an image of a symbol such as a bar code attached to a commodity sold in a transaction to acquire a commodity code assigned thereto. The commodity registration processing refers to processing in which the POS terminal 1 displays a commodity name and a price of a commodity based on commodity information (e.g., a commodity name, a price, and the like) of the commodity acquired based on its commodity code and stores the commodity information in a commodity information area 131 (see FIG. 3). The POS terminal 1 may optically read an image of a symbol attached to a commodity and acquire the corresponding commodity code.

When the POS terminal 1 executes commodity registration processing and price reduction is applied to a commodity, the POS terminal 1 stores a price reduction amount in the commodity information area 131. Additionally, the POS terminal 1 stores a total reduction amount in one transaction in a total reduction area 133.

Here, price reduction processing performed by the POS terminal 1 will be described. The price reduction processing includes commodity price reduction processing (hereinafter simply referred to as “commodity price reduction”) for individually reducing a price of a commodity and total price reduction processing (hereinafter simply referred to as “total price reduction”) for reducing a total amount in one transaction. Possible commodity price reductions include, for example, applying a special sale event price reduction on a special sale commodity for any customer, a time zone price reduction on a specific commodity purchased during a specific time period, a member price reduction on a commodity for a member or registered customer, a manufacturer's price reduction on a commodity designated by a manufacturer, a coupon price reduction on a specific commodity associated with a coupon, a closeout price reduction on a closeout commodity, and a sticker price reduction on a commodity to which a price reduction sticker or tag is attached.

A total price reduction includes applying a “combo” price reduction to the transaction total if a combination of certain commodities is purchased or a designated total number of commodities is purchased in the transaction, a transaction threshold price reduction to the transaction total if the total amount is greater than or equal to a predetermined amount, a member total price reduction to the transaction total if the customer is a loyalty program member (or according to a membership rank or level of the member), a coupon total price reduction to the transaction total when a coupon to reduce a total transaction price is presented, and the like. Such price reductions may be applied by individual stores according to the promotional strategy of the store. The price reductions described above are non-limiting examples. Other price reduction types may be applied to individual commodities or to the transaction total.

The settlement processing includes: processing of displaying the total amount of payment in a transaction calculated based on the commodity information stored in the commodity information area 131 by the commodity registration processing, processing of calculating and displaying the amount of bills and coins received from a customer, and processing of instructing a change machine to return change. The settlement processing further includes processing of issuing a receipt on which commodity information acquired in the commodity registration processing and settlement information (e.g., a total amount, a payment amount, a change amount, and the like) are printed. The commodity information includes price reduction information obtained in commodity price reduction processing. The settlement information includes price reduction information obtained in total price reduction processing. Information printed on a receipt is referred to as transaction information, and includes at least information of a receipt header and a total reduction amount in addition to the commodity information and the settlement information. The total reduction amount is obtained by totaling all reduction amounts obtained in price reduction processing (i.e., commodity price reduction and total price reduction) in one transaction. Here, the header information may be a notation including any one of or a plurality of, for example, a notation indicating a receipt (for example, characters such as “account statement”, “receipt”, and “receipt note”) and a logo specifying a store that issues the receipt.

The POS terminal 1 according to an embodiment prints a total reduction amount on a receipt with highlighted text. By printing the total reduction amount in this manner, a customer including a member can easily confirm how much is reduced in total in one transaction. On a receipt, price reduction amounts for targets (i.e., each commodity and the total amount) subjected to the price reduction processing are printed in association with corresponding targets and the total reduction amount is printed with highlighted text, so that the price reduction amount in one transaction can be easily understood. Therefore, a customer can be given a feeling of gain through the price reduction, and it is expected to motivate the customer to visit a store again, which contributes to its sales.

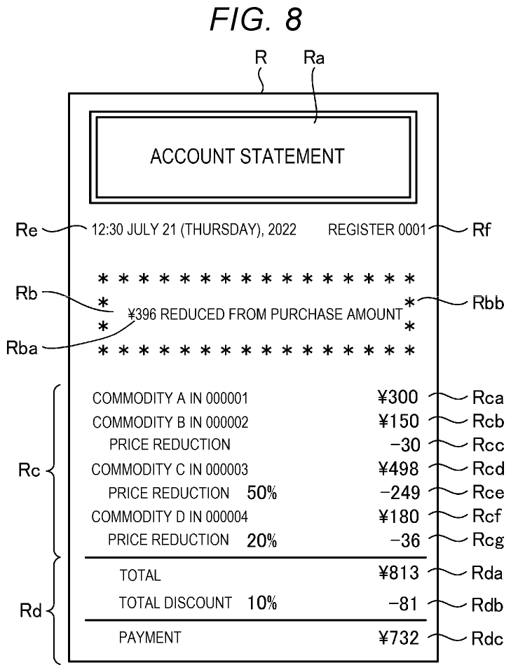

The highlighted printing of a total reduction amount on a receipt includes, for example, printing the total reduction amount close to a receipt header of a store, printing the total reduction amount by surrounding the total reduction amount with, for example, a special symbol (for example, “*” symbol), and printing the total reduction amount with highlight characters (enlarged characters or bold characters). If a receipt can be printed in color, a total reduction amount may be highlighted in a conspicuous color different from other kinds of print. Printing in a more highlighted manner can be performed by combining the highlighted printing described above. For example, a total reduction amount can be printed in a more highlighted manner by printing the total reduction amount in the vicinity of a receipt header in a manner of surrounding the total reduction amount with a special symbol. The highlighted printing of a total reduction amount on a receipt is also achieved by printing in highlight total price reduction information Rb to be described later with reference to FIG. 8.

A style in which a total reduction amount is highlighted may be programmed in advance or may be selected and set.

The POS terminal 1 transmits commodity information and settlement information of a commodity subjected to settlement processing to the server 2 via the communication line L. The POS terminal 1 may transmit a total reduction amount or transaction information to the server 2.

The server 2 centrally manages commodity information, settlement information, and the like received from each POS terminal 1. That is, the server 2 performs sales management and the like in one store. Further, the server 2 transmits information related to a latest commodity master database 142 (hereinafter simply referred to as the commodity master 142) (see FIG. 3) to each POS terminal 1.

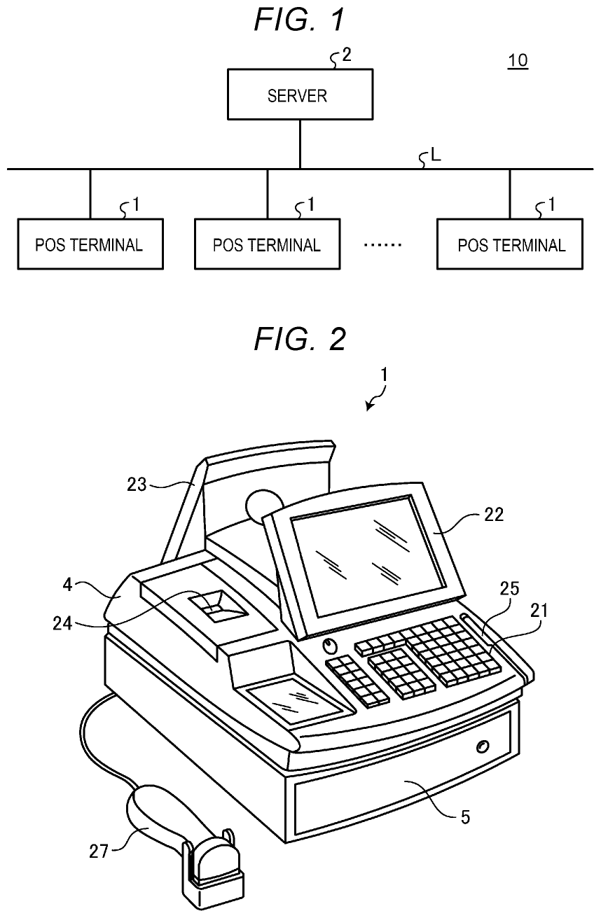

FIG. 2 is a perspective view showing the POS terminal 1 as viewed from an operator side.

The POS terminal 1 includes a main body 4 and a cash storage box 5. The cash storage box 5 has a drawer for storing cash such as coins and bills, valuable securities such as gift certificates, and the like.

The main body 4 includes an operation unit 21, an operator display unit 22, a customer display unit 23, a printing unit 24, a card reading unit 25, and a code reader 27. The operation unit 21 is a keyboard including keys such as numeric keys for inputting numerals. The operator display unit 22 is a liquid crystal display (LCD) or the like, and displays commodity information, settlement information, and the like for an operator who operates the POS terminal 1. The customer display unit 23 is an LCD or the like, and displays commodity information, settlement information, and the like for a customer.

The printing unit 24 is a printer that draws out a roll of receipt sheet stored in the main body 4, prints commodity information, settlement information, receipt header information, total reduction amount information, and the like, and issues a receipt. The receipt header information is stored in the POS terminal 1 in advance. For example, the printing unit 24 has a heat transfer type print head. The card reading unit 25 is a card reader that reads a card ID for specifying a card such as a credit card or a point card presented by a customer. The code reader 27 is, for example, a handy device. The code reader 27 images and reads a symbol attached to a commodity using, for example, visible light. The code reader 27 may read a symbol using an optical scanner. The code reader 27 reads a symbol that is written on a member card and includes a member code for specifying a member.

Hereinafter, a hardware configuration of the POS terminal 1 will be described. In the following description, a price reduction amount is set for each commodity, and commodity price reduction processing for a price of a commodity and total price reduction processing for a total amount for purchase will be described as an example of price reduction processing performed by the POS terminal 1.

FIG. 3 is a block diagram showing a hardware configuration of the POS terminal 1. As shown in FIG. 3, the POS terminal 1 includes a central processing unit (CPU) 11, a read only memory (ROM) 12, a random access memory (RAM) 13, and a storage unit 14. The CPU 11 is an example of a processor. The ROM 12 stores various programs. The programs and various kinds of data are loaded in the RAM 13. The storage unit 14 also stores various programs. The CPU 11, the ROM 12, the RAM 13, and the storage unit 14 are connected to one another via a bus 15. The CPU 11, the ROM 12, and the RAM 13 constitute a control unit (or main controller) 100. That is, the control unit 100 or the CPU 11 executes control processing related to the functions of the POS terminal 1 to be described later in accordance with a control program stored in the ROM 12 or the storage unit 14 and loaded in the RAM 13.

The RAM 13 stores the commodity information area 131, a member information area 132, and the total reduction area 133. The commodity information area 131 stores commodity information (e.g., a commodity name, a commodity price, a price reduction amount, and the like) of a commodity subjected to commodity registration processing based on a commodity code acquired from a symbol read by the code reader 27.

The member information area 132 stores a member code acquired from a symbol read by the code reader 27. The total reduction area 133 stores a total reduction amount obtained by adding price reduction amounts calculated in price reduction in one transaction. That is, the total reduction area 133 stores a sum of price reduction amounts calculated in commodity price reduction and a reduction amount calculated in total price reduction in one transaction. If there are some commodities to which commodity price reduction is applied, but no total price reduction is applied in one transaction (for example, if a customer is not a member), a sum of the price reduction amounts becomes the total reduction amount.

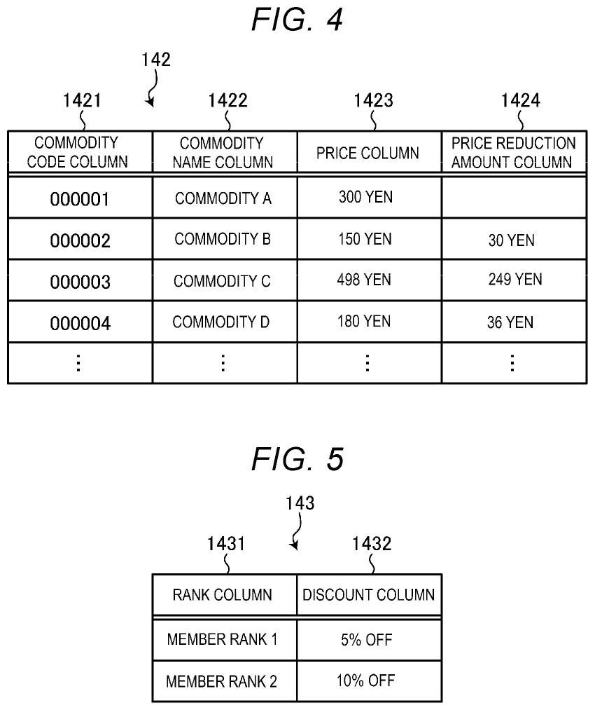

The storage unit 14 is implemented by a nonvolatile memory such as a hard disc drive (HDD) or a flash memory in which stored information is maintained even when the power is turned off. The storage unit 14 includes a control program area 141, the commodity master 142, and a member price reduction table 143. The control program area 141 stores a control program for controlling the POS terminal 1. The commodity master 142 stores, for each commodity, commodity information (e.g., a commodity name, a unit price, and the like) related to the commodity. The commodity master 142 will be described later with reference to FIG. 4. The member price reduction table 143 stores, for each member rank, a discount rate to be applied to a total amount of purchase according to a member rank. The member price reduction table 143 will be described later with reference to FIG. 5.

The control unit 100 is connected to the operation unit 21, the operator display unit 22, the customer display unit 23, the printing unit 24, the card reading unit 25, and the code reader 27 via the bus 15 and an interface controller 16. The interface controller 16 receives an instruction from the control unit 100 and controls the operation unit 21, the operator display unit 22, the customer display unit 23, the printing unit 24, the card reading unit 25, and the code reader 27. In the following description, control performed by the interface controller 16 is performed by the control unit 100 for the convenience of description.

The operation unit 21 is a keyboard. The keyboard may be a touch key provided on the operator display unit 22 and/or the customer display unit 23. The operation unit 21 includes a settlement key 211. The settlement key 211 is operated if commodity registration processing is ended and is transitioned to settlement processing.

The control unit 100 is connected to the communication unit 26 via the bus 15. The communication unit 26 is a communication interface circuit that is electrically connected to the other POS terminals 1 and the server 2 installed in the store via the communication line L.

Subsequently, the commodity master 142 will be described. FIG. 4 shows a data structure of the commodity master 142. The commodity master 142 stores various kinds of information about commodities in association with their commodity code.

As shown in FIG. 4, the commodity master 142 includes a commodity code column 1421, a commodity name column 1422, a price column 1423, and a price reduction amount column 1424. The commodity code for specifying a commodity is stored in the commodity code column 1421 for each commodity. The commodity name of a commodity specified by a commodity code stored in the commodity code column 1421 is stored in the commodity name column 1422 in association with the commodity code. The price of a commodity specified by a commodity code stored in the commodity code column 1421 is stored in the price column 1423 in association with the commodity code. Here, the price of a commodity is a regular price without any price reduction.

The price reduction amount of a commodity specified by a commodity code stored in the commodity code column 1421 is stored in the price reduction amount column 1424 in association with the commodity code. In the example shown in FIG. 4, no price reduction amount information is stored in the price reduction amount column 1424 for a commodity A with a commodity code “000001”. In this case, the control unit 100 determines that the commodity A is a commodity without price reduction (i.e., the commodity A is not a price reduction target commodity). Price reduction amounts are stored in the price reduction amount column 1424 for a commodity B with a commodity code “000002”, a commodity C with a commodity code “000003”, and a commodity D with a commodity code “000004”. In such a case, the control unit 100 determines that the commodity B, the commodity C, and the commodity D are price reduction target commodities for which price reduction is to be performed.

Although a price reduction amount is stored in the price reduction amount column 1424 in FIG. 4, a discount rate may be stored in the price reduction amount column 1424 for each commodity. In such a case, the control unit 100 calculates a price reduction amount of a commodity based on the price of the commodity stored in the price column 1423 and the discount rate stored in the price reduction amount column 1424.

Next, a price reduction for a member based on the member price reduction table 143 will be described. A customer registered as a member may have a member rank corresponding to a total spending at the store in a predetermined period (for example, one year). A member with a high rank (for example, a member whose total spending is larger than a predetermined amount) may receive a greater discount from the store. In an embodiment, a discount rate for discounting a total amount is set for each member rank. FIG. 5 is a data structure of the member price reduction table 143 in which a discount rate for discounting a total amount in a transaction is set for each member rank.

As shown in FIG. 5, the member price reduction table 143 includes a rank column 1431 and a discount column 1432. A member rank is stored in the rank column 1431. A discount rate for each member rank is stored in the discount column 1432 in association with a rank. In the case of the example shown in FIG. 5, a member with a member rank 1 (e.g., a member with a regular rank) has 5% OFF from a total amount in one transaction. A member with a member rank 2 (e.g., a member with a rank higher than a regular rank) has 10% OFF from a total amount in one transaction. The control unit 100 calculates a price reduction amount for a member based on a total amount of purchase by the member in a transaction, a rank of the member, and a discount rate stored in the discount column 1432. A price reduction amount set for each member rank may be stored in the discount column 1432.

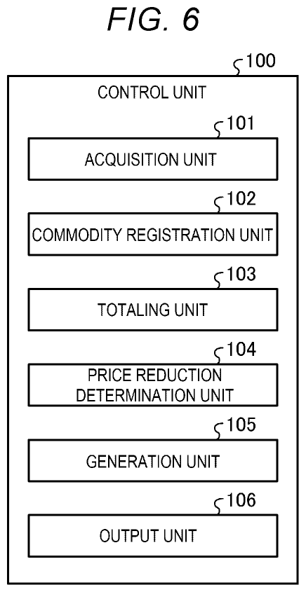

Hereinafter, a functional configuration of the POS terminal 1 will be described. FIG. 6 is a functional block diagram of the POS terminal 1. The control unit 100 performs the functions of an acquisition unit 101, a commodity registration unit 102, a totaling unit 103, a price reduction determination unit 104, a generation unit 105, and an output unit 106 by executing a control program stored in the control program area 141 of the ROM 12 or the storage unit 14.

The acquisition unit 101 acquires a commodity code for specifying a commodity. Specifically, the acquisition unit 101 acquires a commodity code based on a symbol attached to a commodity and read by the code reader 27.

The commodity registration unit 102 executes commodity registration processing on a commodity based on the commodity code acquired by the acquisition unit 101.

The totaling unit 103 totals a price reduction amount of a price reduction target commodity based on the commodity code acquired by the acquisition unit 101. Specifically, the totaling unit 103 searches the commodity master 142 using the commodity code acquired by the acquisition unit 101, and adds the price reduction amount stored in the price reduction amount column 1424 in association with the commodity code to the amount stored in the total reduction area 133. In an embodiment, if price reduction for a member is applied to the total amount based on the member price reduction table 143 shown in FIG. 5, the totaling unit 103 adds the total price reduction amount to the amount stored in the total reduction area 133.

The price reduction determination unit 104 determines whether price reduction processing is performed in one transaction. Specifically, the price reduction determination unit 104 determines whether price reduction processing is performed in one transaction based on whether any amount is stored in the total reduction area 133. When any reduction amount is stored in the total reduction area 133, the price reduction determination unit 104 determines that price reduction processing is performed in one transaction. When no amount is stored in the total reduction area 133, the price reduction determination unit 104 determines that price reduction processing is not performed in one transaction.

The generation unit 105 generates visual transaction information related to sales of a commodity in which the total reduction amount is highlighted. Specifically, the generation unit 105 generates print information that is the visual transaction information related to sales of a commodity in which the total reduction amount is highlighted. The generation unit 105 according to an embodiment highlights the total reduction information Rb (see FIG. 8) including the total reduction amount.

The output unit 106 outputs the generated transaction information. Specifically, the output unit 106 outputs the generated print information to the printing unit 24.

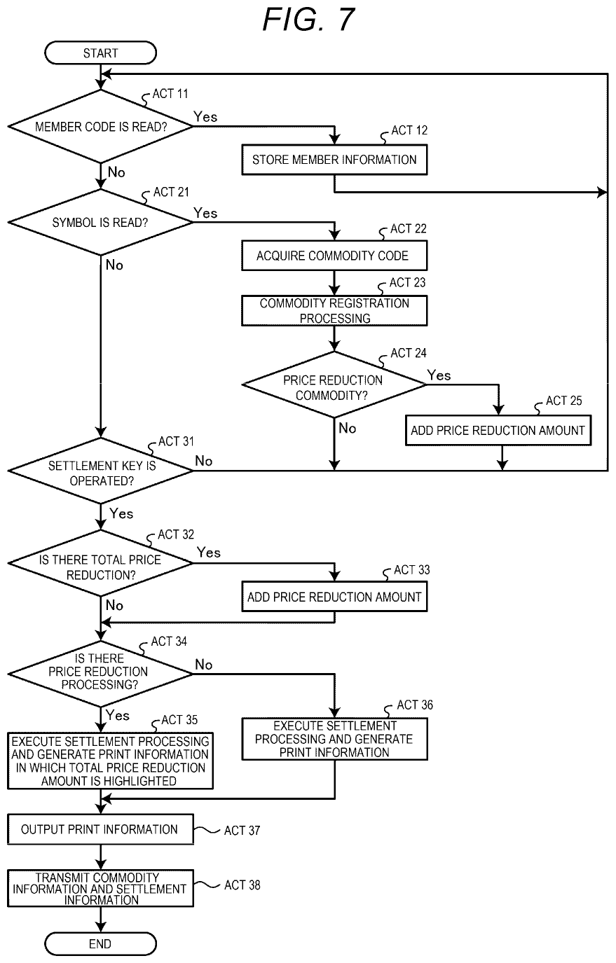

Hereinafter, control of the POS terminal 1 will be described. FIG. 7 is a flowchart of control processing performed by the POS terminal 1. As shown in FIG. 7, the control unit 100 of the POS terminal 1 determines whether the code reader 27 reads a symbol printed on a member card (ACT 11). If it is determined that a symbol is read (Yes in ACT 11), the control unit 100 acquires member information based on a member code included in the read symbol, and stores the member information in the member information area 132. The member information includes rank information indicating a rank of the member. The control unit 100 inquires the server 2 about, for example, the member information using the acquired member code. The control unit 100 stores the member information received from the server 2 in the member information area 132. Then, the control unit 100 returns the processing to ACT 11.

If it is determined that a symbol is not read (No in ACT 11), the control unit 100 determines whether the code reader 27 reads a symbol attached to a commodity (ACT 21). If it is determined that a symbol is read (Yes in ACT 21), the acquisition unit 101 analyzes the read symbol and acquires a commodity code for specifying the commodity (ACT 22). Next, the control unit 100 searches the commodity master 142 based on the acquired commodity code, and acquires commodity information (e.g., a commodity name, a price, a price reduction amount, and the like) of the commodity. The commodity registration unit 102 executes commodity registration processing on the commodity based on the acquired commodity information (ACT 23). If a price reduction amount is acquired, the commodity registration unit 102 stores a price of the commodity and the price reduction amount in association with each other in the commodity information area 131 in the commodity registration processing in ACT 23.

Next, the control unit 100 determines whether the commodity whose commodity code is acquired in ACT 22 is a price reduction target commodity (ACT 24). If it is determined in the processing of ACT 23 that a price reduction amount is stored in the price reduction amount column 1424, the control unit 100 determines that the commodity is a price reduction target commodity in ACT 24. If it is determined in the processing of ACT 23 that no price reduction amount is stored in the price reduction amount column 1424, the control unit 100 determines that the commodity is not a price reduction target commodity in ACT 24. If it is determined that the commodity whose commodity code is acquired is a price reduction target commodity (Yes in ACT 24), the totaling unit 103 adds the acquired price reduction amount to the amount stored in the total reduction area 133 (ACT 25). Then, the control unit 100 returns the processing to ACT 11. If it is determined that the commodity whose commodity code is acquired is not a price reduction target commodity (No in ACT 24), the control unit 100 returns the processing to ACT 11.

If it is determined that a symbol is not read by the code reader 27 (No in ACT 21), the control unit 100 determines whether the settlement key 211 is operated (ACT 31). If it is determined that the settlement key 211 is operated (Yes in ACT 31), the control unit 100 determines whether there is total price reduction for members applicable to the total amount (ACT 32). Specifically, the control unit 100 determines whether there is total price reduction applied to the total amount based on whether member information is stored in the member information area 132 (ACT 32). If member information is stored in the member information area 132, the control unit 100 determines that there is total price reduction applied to the total amount. If no member information is stored in the member information area 132, the control unit 100 determines that there is no total price reduction applied to the total amount.

If it is determined that there is total price reduction for the member (Yes in ACT 32), the totaling unit 103 calculates the amount of the total price reduction for the member according to the rank of the member and adds the calculated amount to the amount stored in the total reduction area 133 (ACT 33). If it is determined that there is no total price reduction applied to the member (No in ACT 32), the processing in ACT 33 is not executed.

Next, the price reduction determination unit 104 determines where price reduction is executed in the current transaction (ACT 34). If it is determined that the price reduction processing is executed (Yes in ACT 34), the generation unit 105 executes settlement processing for the transaction, and generates transaction information (or print information) in which at least the total price reduction amount is highlighted based on a commodity information value stored in the commodity information area 131 and the total reduction amount stored in the total reduction area 133 (ACT 35). In an embodiment, the generation unit 105 generates print information in which total reduction information Rb including the total reduction amount is highlighted (ACT 35). The output unit 106 outputs the generated print information to the printing unit 24 (ACT 37). The printing unit 24 prints the output print information on a receipt sheet and issues a receipt.

FIG. 8 is a diagram showing an example of a receipt printed and issued by the printing unit 24 based on the print information output in ACT 37. As shown in FIG. 8, a receipt header Ra indicating a receipt, the total reduction information Rb including the total reduction amount, commodity information Rc, and settlement information Rd are printed on a receipt R.

The receipt header Ra is printed at the top of the receipt R. Since the receipt header Ra is information including characters such as “account statement” indicating a receipt, the receipt header Ra is printed in a conspicuous manner such as large characters. A date Re on which the receipt R is issued and a register number Rf indicating the POS terminal 1 that prints and issues the receipt are printed immediately below the receipt header Ra.

The total reduction information Rb including the total reduction amount Rba stored in the total reduction area 133 is printed immediately below the date Re and the register number Rf. In this example, the price reduction information Rb including a message indicating a price reduction such as “¥396 is reduced from the purchase amount”, and “¥396” which is the total reduction amount Rba reduced in the transaction is printed.

The total reduction information Rb including the total reduction amount Rba is printed close to the receipt header Ra. Since the receipt header Ra is printed in a conspicuous manner, the total reduction amount Rba and the total reduction information Rb printed close to the receipt header Ra are also conspicuous, and thus the total reduction amount Rba and the total reduction information Rb are highlighted. In the example shown in FIG. 8, since the total reduction amount Rba and the total reduction information Rb are printed in a manner of being surrounded in a square shape by conspicuous symbols “*”, the total reduction amount Rba and the total reduction information Rb are highlighted. Further, in the example shown FIG. 8, since the total reduction amount Rba and the total reduction information Rb are printed in bold characters or bold font, the total reduction amount Rba and the total reduction information Rb are highlighted.

The commodity information Rc of commodities purchased by a customer (a member) in the transaction is printed immediately below the total reduction amount Rba and the total reduction information Rb. Specifically, the commodity code, the commodity name, and the commodity price of each purchased commodity are printed, and the reduction amount of each commodity subjected to commodity price reduction is printed immediately below the commodity.

In the example shown in FIG. 8, a commodity code for a commodity A and a commodity price Rca (hereinafter, collectively referred to as “commodity information”) are printed. Since commodity price reduction is not performed for the commodity A, any price reduction amount is not printed. On the other hand, commodity information Rcb for a commodity B is printed. Since the commodity B is reduced in price by 30 yen, a price reduction amount Rcc of the commodity is printed immediately below the commodity information. Commodity information Rcd for a commodity Cis printed. Since the commodity C is reduced in price by 249 yen, a price reduction amount Rce of the commodity is printed immediately below the commodity information. Commodity information Rcf for a commodity D is printed. Since the commodity D is reduced in price by 36 yen, a price reduction amount Reg of the commodity is printed immediately below the commodity information. In this manner, commodity information of a commodity and a price reduction amount of a commodity subjected to price reduction are printed in association with each other on the receipt R as the commodity information Rc.

The total amount Rda obtained by subtracting the price reduction amounts of individual commodities from the total price of purchased commodities, the amount Rdb of the total price reduction since the customer is a member, and the payment amount Rdc to be paid by the member obtained by subtracting the amount Rdb of the total price reduction from the total amount Rda are printed on the receipt R as the settlement information Rd.

Return to FIG. 7, the control unit 100 transmits the transaction information including the commodity information of each purchased commodity subjected to the commodity registration processing and the settlement information subjected to the settlement processing to the server 2 (ACT 38). Then, the control unit 100 ends the processing.

If it is determined in the processing of ACT 34 that there is no price reduction processing (No in ACT 34), the control unit 100 executes settlement processing related to the transaction and generates print information based on the commodity information stored in the commodity information area 131 (ACT 36). In the processing of ACT 36, since no total reduction amount is stored in the total reduction area 133, no total reduction amount and total reduction information are printed.

The POS terminal 1 includes the acquisition unit 101 configured to acquire commodity information for specifying a commodity, the totaling unit 103 configured to total a price reduction amount of a price reduction target commodity based on the acquired commodity information, the generation unit 105 configured to generate print information of visual transaction information related to sales of a commodity in which the total reduction amount is highlighted, and the output unit 106 configured to output the generated transaction information to the printing unit 24. The POS terminal 1 having such a configuration can issue the receipt R in which the total reduction amount is highlighted for a customer, and thus a promotion effect by price reduction can be improved.

In the above-described embodiments, the generation unit 105 generates print information as the transaction information. The disclosure is not limited thereto, and for example, the generation unit 105 may generate electronic receipt information in which a total reduction amount is highlighted as transaction information. In such a case, the output unit 106 outputs the generated transaction information to the server 2 or another host device (or external device). In such a case, the generation unit 105 may generate electronic receipt information in which total reduction information including a total reduction amount is highlighted.

Total price reduction is performed for a member, and the total price reduction amount is added to the total reduction amount. Embodiments are not limited thereto, and it is not essential to perform total price reduction. Even if total price reduction is performed, it is not essential to add the total price reduction amount to the total reduction amount.

Both a price reduction amount calculated in commodity price reduction for each commodity and a total price reduction amount are printed on a receipt in the above-described embodiments. Embodiments are not limited thereto, it is not essential to print a price reduction amount calculated in commodity price reduction for each commodity.

The generation unit 105 generates print information in which total reduction information Rb including a total reduction amount is highlighted in the above-described embodiments. Embodiments are not limited thereto, and the generation unit 105 may generate print information in which at least a total reduction amount is highlighted.

Although the POS terminal 1 is described as an example of a sales data processing apparatus in the above-described embodiments, the sales data processing apparatus may be an apparatus (for example, an electronic cash register (ECR)) other than the POS terminal 1.

A program executed by the POS terminal 1 is stored and copied from a computer-readable recording medium such as a CD-ROM, a flexible disk (FD), a CD-R, or a digital versatile disk (DVD) in a file of an installable format or an executable format.

The program executed by the POS terminal 1 may be stored in a computer connected to a network such as the Internet and downloaded therefrom via the network. The program executed by the POS terminal 1 may be provided or distributed via a network such as the Internet.

The program executed by the POS terminal 1 may be stored in the ROM 12 or the storage device 14 in advance.

While certain embodiments have been described, these embodiments have been presented by way of example only, and are not intended to limit the scope of the inventions. These novel embodiments and modifications thereof can be implemented in various other forms, and various omissions, replacements, and modifications can be made without departing from the gist of the disclosure. The accompanying claims and their equivalents are intended to cover such embodiments or modifications as would fall within the scope and spirit of the inventions.

What is claimed is:

1. A point of sale (POS) terminal for registering commodities for purchase at a store, comprising:
a code reader;
a memory that stores a commodity master with an entry for each commodity sold at a store in association with a full price for the commodity and a discount amount; and
a processor configured to:
upon reading of a code via the code reader, register a commodity corresponding to the code in a transaction,
calculate a total amount of payment due in the transaction based on the full price and the discount amount of the registered commodity,
generate transaction information indicating an image of a receipt of the transaction, the image including first text indicating the total amount of payment due and second text indicating a total amount of discount, the second text being highlighted relative to the first text, and
output the transaction information for printing.

2. The POS terminal according to claim 1, further comprising:
a printer, wherein
the processor is configured to control the printer to print the receipt using the transaction information.

3. The POS terminal according to claim 1, wherein
the processor is configured to generate the transaction information such that the image includes a header to be printed adjacent to the second text.

4. The POS terminal according to claim 1, wherein
the processor generates the transaction information such that the image includes symbols surrounding the second text.

5. The POS terminal according to claim 1, wherein
the processor generates the transaction information such that the second text is printed in bold font.

6. The POS terminal according to claim 1, wherein
the memory stores a table with an entry for each customer of the store in association with a discount amount, and
the processor is configured to:
upon reading of a customer code via the code reader, identify a customer corresponding to the customer code, and
calculate the total amount of payment due in the transaction based further on the discount amount corresponding to the identified customer.

7. The POS terminal according to claim 1, further comprising:
a communication interface, wherein
the processor is configured to:
generate electronic receipt information corresponding to the receipt, and
control the communication interface to transmit the electronic receipt information to an external device.

8. A method for registering commodities for purchase at a store, the method comprising:
reading a code via a code reader, and registering a commodity corresponding to the code in a transaction;
determining a full price and a discount amount of the commodity using a commodity master;
calculating a total amount of payment due in the transaction based on the full price and the discount amount of the commodity;
generating transaction information indicating an image of a receipt of the transaction, the image including first text indicating the total amount of payment due and second text indicating a total amount of discount, the second text being highlighted relative to the first text; and
outputting the transaction information for printing.

9. The method according to claim 8, further comprising:
printing the receipt using the transaction information.

10. The method according to claim 8, wherein
the transaction information is generated such that the image includes a header to be printed adjacent to the second text.

11. The method according to claim 8, wherein
the transaction information is generated such that the image includes symbols surrounding the second text.

12. The method according to claim 8, wherein
the transaction information is generated such that the second text is printed in bold font.

13. The method according to claim 8, further comprising:
reading a customer code, and identifying a customer corresponding to the customer code, and
determining a discount amount corresponding to the identified customer, wherein
the total amount of payment due in the transaction is calculated based further on the discount amount corresponding to the identified customer.

14. The method according to claim 8, further comprising:
generating electronic receipt information corresponding to the receipt; and
transmitting the electronic receipt information to an external device.

15. A non-transitory computer readable medium storing a program causing a computer to execute a method for registering commodities for purchase at a store, the method comprising:
reading a code via a code reader, and registering a commodity corresponding to the code in a transaction;
determining a full price and a discount amount of the commodity using a commodity master;
calculating a total amount of payment due in the transaction based on the full price and the discount amount of the commodity;
generating transaction information indicating an image of a receipt of the transaction, the image including first text indicating the total amount of payment due and second text indicating a total amount of discount, the second text being highlighted relative to the first text; and
outputting the transaction information for printing.

16. The computer readable medium according to claim 15, wherein the method further comprises:
printing the receipt using the transaction information.

17. The computer readable medium according to claim 15, wherein
the transaction information is generated such that the image includes a header to be printed adjacent to the second text.

18. The computer readable medium according to claim 15, wherein
the transaction information is generated such that the image includes symbols surrounding the second text.

19. The computer readable medium according to claim 15, wherein
the transaction information is generated such that the second text is printed in bold font.

20. The computer readable medium according to claim 15, wherein the method further comprises:
reading a customer code, and identifying a customer corresponding to the customer code, and
determining a discount amount corresponding to the identified customer, wherein
the total amount of payment due in the transaction is calculated based further on the discount amount corresponding to the identified customer.
